(19) United States
(12) Patent Application Publication
(10) Pub. No.: US 2013/0000901 A1
(43) Pub. Date: Jan. 3, 2013

(54) Methods for Stimulating Oil or Gas Production Using a Viscosified Aqueous Fluid with a Chelating Agent to Remove Calcium Carbonate and Similar Materials from the Matrix of a Formation or a Proppant Pack

(75) Inventor: Thomas D. Welton, Houston, TX (US)

(73) Assignee: Halliburton Energy Services, Inc., Houston, TX (US)

(21) Appl. No.: 13/611,424

(22) Filed: Sep. 12, 2012

Related U.S. Application Data
(63) Continuation of application No. 11/801,209, filed on May 10, 2007.

(51) Int. Cl. E21B 43/267; C09K 8/86

(52) U.S. Cl. 166/280.2; 507/241

(57) ABSTRACT

Methods for treating a subterranean formation can comprise introducing a treatment fluid comprising dicarboxymethyl glutamic acid (GLDA) or a salt thereof into a subterranean formation, the treatment fluid having a pH equal to or greater than about 2. Fluids suitable for treating a subterranean formation can comprise water, GLDA or a salt thereof, and a surfactant.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### TECHNICAL FIELD

The invention generally relates to production enhancement to increase hydrocarbon production from a subterranean formation. More particularly, the invention relates to methods of treating a portion of a matrix of a subterranean formation or a proppant pack in a pre-existing fracture or perforation to increase permeability and enhance production, some of which techniques are referred to as near-wellbore stimulation.

### SUMMARY OF THE INVENTION

According to the invention, a method for treating a portion of a subterranean formation or a proppant pack is provided. In general, the method comprises the steps of: (A) forming or providing a treatment fluid comprising: (i) water; (ii) a chelating agent capable of forming a heterocyclic ring that contains a metal ion attached to at least two nonmetal ions; and (iii) a viscosity-increasing agent; and (B) introducing the treatment fluid into the wellbore under sufficient pressure to force the treatment fluid into the matrix of the formation or the proppant pack.

Other and further objects, features and advantages of the present invention will be readily apparent to those skilled in the art when the following description of the preferred embodiments is read in conjunction with the accompanying drawings

### DETAILED DESCRIPTION OF A PREFERRED EMBODIMENT

In general, the purpose of this invention is to improve delivery of a chelating agent for production enhancement by increasing the viscosity of the treatment fluid. A chelating agent can be utilized to help dissolve and remove carbonates and other minerals from the matrix of the subterranean formation or the proppant pack. The concentration of the chelating agent is sufficient to help dissolve a substantial amount of carbonate material. The treatment fluid containing the chelating agent includes a viscosity-increasing agent to help with placement of the fluid into the formation or proppant pack or to help with diversion of the treatment fluid. When the viscosity of the fluid is increased or gelled, the treatment fluid can provide better coverage and diversion, and thereafter be broken for flowback from the well. The treatment fluid can be a single fluid that dissolves calcium/magnesium/iron carbonate solids in the matrix of the near region surrounding a wellbore, a pre-existing gravel pack, a pre-existing perforation, or a pre-existing fracture or that dissolves these solids in a proppant pack in a pre-existing perforation or a pre-existing fracture. The treatment fluid dissolves such solids at a controlled rate and under a wide range of conditions, especially over a broad range of pH and time. The invention can be advantageous because it can provide methods for treating the matrix of a subterranean formation or a pre-existing proppant pack for such purposes using treatment fluids that are non-acid containing and non-corrosive.

The treatment methods according to the invention are expected to be effective for applications associated with well completion and remediation, including: removal of carbonate scale from the formation and fractures in the formation; removal of carbonate from formations or proppant packs where the carbonate lines pore throats; stimulation for carbonate containing formations where the use of acidic fluids might be problematic, for example, in high-temperature formations due to reaction rates, or due to corrosion, etc. For a stimulation treatment, the purpose is to improve the skin of the matrix of the formation over its original condition, and a greater depth of matrix penetration is desirable. For a damage removal treatment, such as after a prior gel treatment or completion damage, less depth of penetration can be sufficient (all else being equal), where the purpose of the damage removal is to get the permeability of the matrix of the formation back toward its original condition. According to a presently preferred embodiment, the treatment method is used as a remedial cleanup after a prior stimulation treatment.

As used herein, the words “comprise,” “has,” and “include” and all grammatical variations thereof are each intended to have an open, non-limiting meaning that does not exclude additional elements or steps.

In general, the new approach is a method for treating a portion of a subterranean formation or proppant pack, the method comprising the steps of: (A) forming or providing a treatment fluid comprising: (i) water; (ii) a chelating agent capable of forming a heterocyclic ring that contains a metal ion attached to at least two nonmetal ions; and (iii) a viscosity-increasing agent; and (B) introducing the treatment fluid into the wellbore under sufficient pressure to force the treatment fluid into the matrix of the formation or the proppant pack. As used herein, “into the matrix of the formation or the proppant pack” means into the rock around the wellbore, a pre-existing perforation, or a pre-existing fracture, or into the matrix of a proppant pack in a gravel pack in the wellbore, a pre-existing perforation, or a pre-existing fracture. The method is adapted to be used after drilling a wellbore, either during completion or remediation of a well.

It is believed that the chelating agent in the treatment fluid can react with and dissolve calcium carbonate, magnesium carbonate, dolomite, iron carbonate, and similar materials of the formation to increase the permeability of the formation. It can also be used to help remove carbonate from formations where the carbonate lines the pore throats in the matrix of the formation, whereby the permeability of the formation can be increased and hydrocarbon production enhanced. It is desirable to allow the treatment fluid to contact the matrix of the formation or the proppant pack for a sufficient time to dissolve such carbonate materials. CaCO₃ is known as limestone; and CaMg(CO₃)₂ is known as dolomite or dolomitic limestone, both of which are minerals that are often present in subterranean formations or which may precipitate from water as scale in subterranean formations or proppant packs. Typical scales are of calcium carbonate, calcium sulfate, barium sulfate, strontium sulfate, iron sulfide, iron oxides, iron carbonate, various silicates and phosphates and oxides, or any of a number of compounds insoluble or slightly soluble in water. Although it may not be expected to dissolve all of the components of scale, the chelating agent can be helpful in removing calcium carbonate, magnesium carbonate, dolomite, iron carbonate, and similar materials of scale.

As used herein, to chelate means to combine a metal ion with a chemical compound to form a ring. “The adjective chelate, derived from the great claw or chela (chely-Greek) of the lobster or other crustaceans, is suggested for the caliper like groups which function as two associating units and fasten to the central atom so as to produce heterocyclic rings.” Sir Gilbert T. Morgan and H. D. K. Drew [J. Chem. Soc., 1920, 117, 1456].

Preferably, the water further includes a water-soluble inorganic salt dissolved therein. The purpose of the inorganic salt can be, for example, to weight the water of the treatment fluid or to make the treatment fluid more compatible and less damaging to the subterranean formation. It should be understood, of course, that a source of at least a portion of the water and the inorganic salt can be selected from the group consisting of natural or synthetic brine or seawater. Inorganic salt or salts can also be mixed with the water of the treatment fluid to artificially make up or increase the inorganic salt content in the water. Alternatively for these types of purposes, a water-soluble salt replacement can be utilized such as tetramethyl ammonium chloride (TMAC) and similar organic compounds.

It is a particular advantage of the method according to the invention to be able to help remove carbonate and similar materials without the use of strongly acidic treatment compositions, that is, without the use of treatment compositions having a pH less than 2. According to a preferred embodiment of the invention, the pH of the treatment fluid is equal to or greater than 2, which is above the pH of strong inorganic acids that have been used to help dissolve and remove carbonate materials from the formation.

More preferably, according to the invention, the pH of the treatment fluid is equal to or greater than 5, which is well above the pH of spent acid fluids used for the purpose of removing carbonate, where the pH of an acid fluid is typically less than about 3.5. The compositions of the present invention can be used to help dissolve and remove carbonate materials from the formation with less acidic compositions. In some applications, acidic compositions can be damaging to the well or hydrocarbon production.

Most preferably, according to the invention, the pH of the treatment fluid is in the range of 6-12, which can be used to avoid or reduce the use of substantially acidic compositions in treating the formation. It is important to note, of course, that different chelating agents work better in certain pH ranges than other ranges. Some chelating agents can be effective in the higher pH ranges. One skilled in the art would also recognize the obvious advantage of using a non-acid fluid may reduce the rate of corrosion.

In particular, the chelating agent is selected to be effective for chelating at least calcium ions. It is also highly desirable that the chelating agent is soluble in distilled water at standard temperature and pressure at a concentration of at least 0.2 mole-equivalent for calcium ions per liter of the distilled water. As a test for whether or not the chelating agent would be effective for use in the present invention, it is believed that a solution of the chelating agent at a concentration of 0.2 mole-equivalent for calcium ions per liter of the distilled water should be effective for chelating at least 0.1 mole calcium ions per liter. Preferably, the test solution is effective when adjusted to have a pH in the range of 5-6. More preferably, the test solution is effective when adjusted to have a pH in the range of 6-8. One skilled in the art would recognize that similar tests can be performed for other ions such as magnesium, iron, etc.

There are numerous examples of suitable chelating agents. For various reasons including effectiveness, ready availability, and economical cost, the chelating agent is preferably selected from the group consisting of ethylenediamine tetraacetic acid (“EDTA”), nitrilotriacetic acid (“NTA”), hydroxyethylethylenediaminetriacetic acid (“HEDTA”), diethylenetriaminepentaacetic acid (“DTPA”), propylenediaminetetraacetic acid (“PDTA”), ethylenediaminedi(o-hydroxyphenylacetic) acid (“EDDHA”), a sodium or potassium salt of any of the foregoing, dicarboxymethyl glutamic acid tetrasodium salt (“GLDA”), a derivative of any of the foregoing or any combination in any proportion thereof. It is to be understood, of course, that a derivative may be employed provided that the substitution of an atom or group of atoms in the parent compound for another atom or group of atoms does not substantially impair the function of the derivative relative to the parent compound. A derivative would also include compounds that do not have the functionality, but would regain functionality due to some process in use such as a reaction, hydrolysis, degradation, etc. The chelating agent is preferably at a concentration of at least 0.01% by weight of the water. More preferably, the chelating agent is at a concentration in the range of 1% to 80% by weight of the water.

The viscosity-increasing agent would typically comprise a polymeric material. For various reasons including effectiveness, ready availability, and economical cost, the polymeric material is preferably selected from the group consisting of: guar gum and its derivatives, cellulose derivatives, welan gum, xanthan biopolymer and its derivatives, diutan, and its derivatives, scleroglucan and its derivatives, succinoglycan biopolymer and its derivatives, and any combination of any of the foregoing in any proportion. Derivatives can include, for example, industrially manufactured chemical derivatives, bioengineered chemical derivatives, or naturally occurring derivatives produced by mutated organisms producing the polymer. A preferred polymer is of the nature taught in U.S. Patent Application Serial No. 20060014648, which is incorporated herein by reference in its entirety.

According to another aspect of the invention, the viscosity-increasing agent can advantageously comprise a viscoelastic surfactant. One perceived advantage of a surfactant gel is that it has much less potential for leaving a polymer residue. The viscoelastic surfactant may comprise any viscoelastic surfactant known in the art, any derivative thereof, or any combination thereof. As used herein, the term “viscoelastic surfactant” refers to a surfactant that imparts or is capable of imparting viscoelastic behavior to a fluid due, at least in part, to the association of surfactant molecules to form viscosifying micelles. These viscoelastic surfactants may be cationic, anionic, nonionic, or amphoteric/zwitterionic in nature.

The viscoelastic surfactants may comprise any number of different compounds, including methyl ester sulfonates (e.g., as described in U.S. patent application Ser. Nos. 11/058,660, 11/058,475, 11/058,612, and 11/058,611, filed Feb. 15, 2005, each of which is assigned to Halliburton Energy Services, Inc., the relevant disclosures of which are incorporated herein by reference), hydrolyzed keratin (e.g., as described in U.S. Pat. No. 6,547,871 issued Apr. 15, 2003 to Halliburton Energy Services, Inc., the relevant disclosure of which is incorporated herein by reference), sulfosuccinates, taurates, amine oxides, ethoxylated amides, alkoxylated fatty acids, alkoxylated alcohols (e.g., lauryl alcohol ethoxylate, ethoxylated nonyl phenol), ethoxylated fatty amines, ethoxylated alkyl amines (e.g., cocoalkylamine ethoxylate), betaines, modified betaines, alkylamidobetaines (e.g., cocoamidopropyl betaine), quaternary ammonium compounds (e.g., trimethyltallowammonium chloride, trimethylcocoammonium chloride), derivatives of any of the foregoing, and any combinations of any of the foregoing in any proportion.

Suitable viscoelastic surfactants may comprise mixtures of several different compounds, including but not limited to: mixtures of an ammonium salt of an alkyl ether sulfate, a cocoamidopropyl betaine surfactant, a cocoamidopropyl dimethylamine oxide surfactant, sodium chloride, and water; mixtures of an ammonium salt of an alkyl ether sulfate surfactant, a cocoamidopropyl hydroxysultaine surfactant, a cocoamidopropyl dimethylamine oxide surfactant, sodium chloride, and water; mixtures of an ethoxylated alcohol ether sulfate surfactant, an alkyl or alkene amidopropyl betaine surfactant, and an alkyl or alkene dimethylamine oxide surfactant; aqueous solutions of an alpha-olefinic sulfonate surfactant and a betaine surfactant; and any combination of the foregoing mixtures in any proportion. Examples of suitable mixtures of an ethoxylated alcohol ether sulfate surfactant, an alkyl or alkene amidopropyl betaine surfactant, and an alkyl or alkene dimethylamine oxide surfactant are described in U.S. Pat. No. 6,063,738, issued May 16, 2000 to Halliburton Energy Services, Inc., the relevant disclosure of which is incorporated herein by reference. Examples of suitable aqueous solutions of an alpha-olefinic sulfonate surfactant and a betaine surfactant are described in U.S. Pat. No. 5,897,699, the relevant disclosure of which is incorporated herein by reference. Examples of commercially-available viscoelastic surfactants suitable for use in the present invention may include, but are not limited to, Mirataine BET-O 30™ (an oleamidopropyl betaine surfactant available from Rhodia Inc., Cranbury, N.J.), Aromox APA-T™ (an amine oxide surfactant available from Akzo Nobel Chemicals, Chicago, Ill.), Ethoquad O/12 PG™ (a fatty amine ethoxylate quat surfactant available from Akzo Nobel Chemicals, Chicago, Ill.), Ethomeen T/12™ (a fatty amine ethoxylate surfactant available from Akzo Nobel Chemicals, Chicago, Ill.), Ethomeen S/12™ (a fatty amine ethoxylate surfactant available from Akzo Nobel Chemicals, Chicago, Ill.), and Rewoteric AM TEG™ (a tallow dihydroxyethyl betaine amphoteric surfactant available from Degussa Corp., Parsippany, N.J.).

According to a preferred embodiment of the invention, the viscosity-increasing agent is at a concentration in the treatment fluid that is at least sufficient to make the viscosity of the treatment fluid greater than water. More preferably, the viscosity-increasing agent is at a concentration in the treatment fluid that is sufficient to make the viscosity of the treatment fluid greater than 5 cP when measured at 511 reciprocal seconds on a Fann 35A model viscometer with a number 1 spring and bob. More preferably, the viscosity-increasing agent is at a concentration in the treatment fluid that is sufficient to make the viscosity of the treatment fluid in the range of 10 cP to 100 cP when measured at 511 reciprocal seconds on a Fann 35A model viscometer with a number 1 spring and bob.

According to another preferred embodiment according to the invention, the viscosity-increasing polymeric agent is at a concentration of at least 0.05% by weight of the water. More preferably, the viscosity-increasing agent is at a concentration in the range of 0.05% to 10% by weight of the water.

It is contemplated that it will sometimes be desirable to further increase the viscosity of the treatment fluid. One technique for doing so is to crosslink a polymeric viscosity-increasing agent. According to such an embodiment of the invention, the treatment fluid further comprises a crosslinking agent to crosslink the polymeric material of the viscosity-increasing agent. A multitude of crosslinking agents for such purposes are known in the art. Preferably, the crosslinking agent is selected from the group consisting of: borate releasing compounds, a source of titanium ions, a source of zirconium ions, a source of antimony ions, a source of aluminum ions, a source of periodate ions, a source of permanganate ions, and any combination thereof in any proportion. According to a preferred embodiment, the crosslinking agent is at a concentration of at least 0.025% by weight of the water. According to a more preferred embodiment of the invention, the crosslinking agent is at a concentration in the range of 0.025% to about 1% by weight of the water. When the treatment fluid for use in the methods according to the invention includes a crosslinking agent, it can also be desirable for the treatment fluid to further include a breaker for the crosslinked agent.

According to another aspect of the invention, the treatment fluid preferably further comprises a breaker adapted to break the viscosity-increasing agent. For example, when the viscosity-increasing agent is polysaccharide based, the breaker is selected to be effective for breaking a polysaccharide-based viscosity-increasing agent. The breaker can be, for example, an enzyme. By way of further example, when the polysaccharide-based viscosity-increasing agent includes starch, the enzyme is selected to be effective for breaking starch. Preferably, an enzyme breaker is at a concentration of at least 0.01 lb per 1000 gal of the water. More preferably, the enzyme breaker is at a concentration in the range of 0.01 lb to 40 lb per 1000 gal of the water. As will be appreciated by persons of skill in the art, however, enzymes are often used as liquid compositions and that the above mentioned values are for fully formulated dry enzyme breakers that typically contain a large percentage of fillers.

When a breaker is employed for the viscosity-increasing agent, the breaker is at a concentration that is at least sufficient to substantially reduce the viscosity produced by the viscosity producing agent in the treatment fluid. In such case, a preferred embodiment of the method according to the invention includes the steps of allowing time for the breaker to break the viscosity of the treatment fluid and then flowing back the broken fluid from the wellbore.

For many types of viscosity-increasing agents, the breaker is preferably an oxidizer selected from the group consisting of: a persulfate; a perborate; a bromate; a periodate; a chlorate; a chlorite; a hypochlorite, an organic peroxide; and any combination thereof in any proportion. Further, the breaker is more preferably selected from the group consisting of a lithium, sodium, potassium, or ammonium salt of any of the foregoing, and any combination thereof in any proportion. The oxidizing breaker for breaking a viscosity-increasing agent internal to the treatment fluid is preferably at a concentration of at least 0.01 lb per 1000 gal of the water. More preferably, such a breaker is at a concentration in the range of 0.1 to 200 per 1000 gal of the water.

It is contemplated that in some applications of the methods according to the invention, it may be desirable that the breaker be a delayed release breaker. One technique for making a delayed breaker is to coat or encapsulate the breaker to delay the release of the breaker into the water. Another technique is to generate the breaker in situ over time or upon a change in pH of the treatment fluid.

According to a preferred embodiment of the invention, the method further includes the step of after introducing the treatment fluid into the wellbore, allowing the viscosity of the treatment fluid to break to a substantially lower viscosity fluid while down hole. According to a further preferred embodiment, the method further comprises the step of: after allowing the viscosity of the treatment fluid to break, flowing the fluid back from the well.

According to further embodiments of the methods of the invention, the treatment fluid can further comprise a breaker to be carried by the treatment fluid into the wellbore for breaking a viscosity-increasing agent that is external of the treatment fluid. According to these embodiments, the breaker for the viscosity-increasing agent in the treatment fluid is preferably at a concentration in an external aqueous fluid that is at least sufficient to substantially break the viscosity of the treatment fluid. The breaker for a viscosity-increasing agent that is external to the treatment fluid can be the same or different than the breaker for the viscosity-increasing agent in the treatment fluid. The additional or different breaker for breaking a viscosity-increasing agent external to the treatment fluid is preferably at a concentration of at least 0.01 lb per 1000 gal of the water. More preferably, the breaker is at a concentration in the range of 0.1 lb to 200 lb per 1000 gal of the water.

It is contemplated that the methods according to the invention can include foaming of the treatment fluid. According to these embodiments, the treatment fluid further comprises: an additive for foaming. The treatment fluid may be formed at a remote location and provided to the well site for the treatment method, or it can be formed locally at the well site. The treatment fluid preferably further comprises: a sufficient gas to form a foam. As used herein, foam also refers to commingled fluids. Preferably, the gas would be mixed with the other constituents of the treatment fluid at the well site to form a foamed or co-mingled fluid. According to a preferred embodiment of the invention, the gas is selected from the group consisting of: air, CO₂, nitrogen, and any combination thereof in any proportion. In applications of the method utilizing a gas, typically, the gas is at a concentration in the range of 5% to 95% by volume of the water.

According to one aspect of the methods of the invention, the step of introducing the treatment fluid into the wellbore further comprises: introducing the treatment fluid at a rate and pressure below the fracture gradient of the subterranean formation. According to a further embodiment, the treatment fluid is applied such that the treatment fluid is introduced such that the proppant pack of a previously generated fracture or gravel pack is treated.

As will be appreciated by those of skill in the art, in the context of using a method according to the invention to treat a portion of the subterranean formation surrounding a wellbore, the permeability of the matrix of the surrounding formation would be expected to be relatively high. According to a further embodiment, the treatment fluid is applied such that the portion of the subterranean formation is a portion surrounding the wellbore, and wherein the treatment fluid is introduced such that the portion surrounding the wellbore is expected to be saturated to a depth of at least 1 foot. More preferably, the treatment fluid is applied such that the portion surrounding the wellbore is expected to be saturated to a depth in the range of 1 foot to 3 feet. Of course, it is recognized that desired or expected depth of penetration into the surrounding matrix of the formation will not necessarily be perfectly uniform. It is also recognized that the parameters for designing a treatment for a desired or expected depth of penetration are well known in the art, including, for example, the length of the wellbore to be treated and the volume of treatment fluid injected into the wellbore. One skilled in the art will recognize that a deeper penetration may be desired or obtained in formations with higher permeability.

In some situations, the permeability of the matrix of the surrounding formation would be expected to be relatively low. According to another embodiment, the portion of the subterranean formation is an area surrounding a fracture extending into the formation, and the treatment fluid is introduced such that the surrounding area is expected to be saturated to a depth of at least 0.1 inches. More preferably, the treatment fluid is introduced into the wellbore under conditions such that the area surrounding the fracture is expected to be saturated to a depth in the range of 0.1 inches to 2 inches. One skilled in the art will recognize that a deeper penetration may be desired or obtained in formations with higher permeability.

According to another embodiment, the portion of the subterranean formation is a perforation tunnel, and the treatment fluid is introduced such that the perforation tunnel and the surrounding area is expected to be saturated to a depth of at least 0.1 inches. More preferably, the treatment fluid is introduced into the wellbore under conditions such that the area surrounding the perforation tunnel is expected to be saturated to a depth in the range of 0.1 inches to 2 inches. One skilled in the art will recognize that a deeper penetration may be desired or obtained in formations with higher permeability.

One of skill in the art will further recognize that for the purpose of treating the matrix of a proppant pack in a pre-existing gravel pack, fracture, or perforation, it may not be necessary or desirable to penetrate into the matrix of the surrounding formation.

According to another aspect of the methods of the invention, the methods further comprise the step of: after the step of introducing the treatment fluid, introducing a non-viscosified treatment fluid into the wellbore, wherein the non-viscosified treatment fluid comprises: water and a chelating agent, without any substantial concentration of any viscosity-increasing agent. According to this aspect, the viscosified treatment fluid is capable of moving into zones of the subterranean formation that have relatively higher permeability, thereby diverting the non-viscosified treatment fluid into zones of the subterranean formation that have relatively lower permeability. According to this aspect, the injection pressure is preferably maintained from the step of introducing the treatment fluid to the step of introducing the non-viscosified treatment fluid.

According to yet another aspect of the methods of the invention, the methods further comprise the step of: applying an afterflush fluid to the portion of the subterranean formation. For example, the afterflush fluid can comprise: water, a gas, a brine, a hydrocarbon, or a mixture thereof.

An example of a treatment fluid for use in the methods according to the invention was formed as shown in the following Table 1:

TABLE 1

| Component | Per 200 ml | | Per 1000 gallons | |
|---|---|---|---|---|
| Water | 157.6 | ml | 788 | US gals |
| H4EDTA 98% | 46.61 | g | 1987 | lbs |
| Potassium Hydroxide Solid 96% | 20.95 | g | 870 | lbs |
| Xanthan | 0.96 | g | 40 | lb/Mgal |

The rheological properties of the example composition were measured on a Fann Model 35 A viscometer as shown in the following Table 2:

TABLE 2

| | 300 rpm | 600 rpm |
|---|---|---|
| Dial Reading at room temperature | 21 | 29 |
| Dial Reading at room temperature | 29 | 35 |
| after 4 hours at 175° F. | | |

Therefore, the methods of the present invention are well adapted to carry out the objects and attain the ends and advantages mentioned as well as those that are inherent therein. While numerous changes may be made by those skilled in the art, such changes are encompassed within the spirit of this invention as defined by the appended claims.

1.-27. (canceled)

28. A method comprising:
introducing a treatment fluid comprising dicarboxymethyl glutamic acid (GLDA) or a salt thereof into a subterranean formation, the treatment fluid having a pH equal to or greater than about 2.

29. The method of claim 28, wherein the pH of the treatment fluid is equal to or greater than about 5.

30. The method of claim 28, wherein the pH of the treatment fluid is between about 6 and about 12.

31. The method of claim 28, wherein the treatment fluid further comprises water.

32. The method of claim 31, wherein the GLDA is present in the treatment fluid at a concentration between about 1% and about 80% by weight of the water.

33. The method of claim 31, wherein the treatment fluid further comprises a surfactant.

34. The method of claim 31, wherein the treatment fluid further comprises a component selected from the group consisting of a surfactant, a water-soluble inorganic salt, a water-soluble inorganic salt replacement, a viscosity-increasing agent, a crosslinking agent, a breaker, a delayed release breaker, an enzyme, an oxidizer, an additive for foaming, a gas, and any combination thereof.

35. A treatment fluid comprising:
water
dicarboxymethyl glutamic acid or a salt thereof (GLDA); and
a surfactant.

36. The treatment fluid of claim 35, wherein the treatment fluid has a pH equal to or greater than about 2.

37. The treatment fluid of claim 35, wherein the treatment fluid has a pH equal to or greater than about 5.

38. The treatment fluid of claim 35, wherein the treatment fluid has a pH between about 6 and about 12.

39. The treatment fluid of claim 35, wherein the GLDA is present in the treatment fluid at a concentration between about 1% and about 80% by weight of the water.

40. The treatment fluid of claim 35, further comprising:
a component selected from the group consisting of a surfactant, a water-soluble inorganic salt, a water-soluble inorganic salt replacement, a viscosity-increasing agent, a crosslinking agent, a breaker, a delayed release breaker, an enzyme, an oxidizer, an additive for foaming, a gas, and any combination thereof.
